(19) United States
(12) Patent Application Publication
(10) Pub. No.: US 2013/0204454 A1
(43) Pub. Date: Aug. 8, 2013

(54) OPTIMAL ENERGY MANAGEMENT AND ENERGY EQUIPMENT CONTROL INTERLOCKING SYSTEM FOR RESIDENTIAL COMPLEX

(71) Applicants: Chang Sic CHOI, Daejeon (KR); Wan Ki PARK, Daejeon (KR); Il Woo LEE, Daejeon (KR)

(72) Inventors: Chang Sic CHOI, Daejeon (KR); Wan Ki PARK, Daejeon (KR); Il Woo LEE, Daejeon (KR)

(73) Assignee: Electronics and Telecommunications Research Institute, Daejeon (KR)

(21) Appl. No.: 13/612,313

(22) Filed: Sep. 12, 2012

(30) Foreign Application Priority Data
Feb. 8, 2012 (KR) 10-2012-0012959

(51) Int. Cl. G06F 1/28

(52) U.S. Cl. 700/295

(57) ABSTRACT

An optimal energy management and energy equipment control interlocking system for a residential complex is provided. The energy management system for managing energy used by a residential complex may include home servers provided in households in the residential complex to collect energy usage information from a plurality of home devices provided in each of the households, to manage the collected energy usage information, and to control energy used by the plurality of home devices, and a complex server for receiving the energy usage information from the home servers to perform integrated management on the received energy usage information, for controlling a corresponding home server based on the received energy usage information, demand response (DR) information, and profile information for saving energy to perform energy saving control in each household, and for controlling energy used by common equipment provided in the residential complex.

### CROSS-REFERENCE TO RELATED APPLICATION

This application claims the priority benefit of Korean Patent Application No. 10-2012-0012959, filed on Feb. 8, 2012, in the Korean Intellectual Property Office, the disclosure of which is incorporated herein by reference.

### BACKGROUND

1. Field of the Invention

The present invention relates to an optimal energy management and energy equipment control interlocking system for a residential complex for optimally managing and controlling energy used by a residential complex such as condominiums, an apartment building, and a multipurpose building in which a large number of households reside.

2. Description of the Related Art

Currently, most residential energy management systems are realized by a home network system based automatically controlled home servers, and provide users with information about an amount of energy used by date, week, and month through in-home displays so that the users recognize the amount of energy used based on the information provided to intuitively save energy. In order to encourage the users to save energy and to use green energy, the government is making an effort to pass legislation directed to supplying green energy to homes through various incentives and regulations.

Recently, home energy management systems (HEMS) in which functions of monitoring and analyzing the amount of energy used are added to conventional home servers are developed to be mainly supplied to new apartments. Access to the HEMS may be made from a distance through a mobile technology so that a control function interlocked with a home network technology may be served.

The HEMS supply energy usage information to the users in a detailed form so that the users may be aware of an actual amount of energy used at home to intuitively save energy.

Introduction of various new generation energies such as solar light, solar heat, geothermal energy, and wind power is being actively examined to correspond to international and continuous increases in energy prices and danger such as destruction of the environment. In particular, a case of applying photovoltaic power generation to buildings in a form of a building integrated photovoltaic system (BIPV) is increasing.

The conventional HEMS simply provides an amount of energy used and does not provide information about patterns of energy usage and devices that use energy inefficiently. Therefore, it is difficult to continuously encourage the users to intuitively participate in saving energy. In addition, in order to control the BIPV effectively, it is necessary to perform optimal control of energy charging and discharging, and to actively perform optimal central control of energy equipment such as a condensing plate, electric blinds, and a horizontal awning in consideration of energy usage status information and weather information.

### SUMMARY

An aspect of the present invention provides an optimal energy management and energy equipment control interlocking system for a residential complex capable of optimizing a service for controlling a conventional home energy management system (HEMS), passively managed energy equipment, and new generation energy and of providing a service for controlling new generation energy and equipment in consideration of weather information.

Another aspect of the present invention also provides an optimal energy management and energy equipment control interlocking system for a residential complex capable of being easily realized in a residential complex such as apartment buildings in which most of an urban population lives, of providing a service for saving energy in each household, a service for saving energy in each complex, and a service for optimally managing new generation energy and electric blinds provided in a form of common equipment, and of providing a demand response (DR) interlocked technology for being interlocked with a smart grid technology.

According to an aspect of the present invention, there is provided an energy management system for managing energy used by a residential complex, including home servers provided in households in the residential complex to collect energy usage information from a plurality of home devices provided in each of the households, to manage the collected energy usage information, and to control energy used by the plurality of home devices and a complex server for receiving the energy usage information from the home servers to perform integrated management on the received energy usage information, for controlling a corresponding home server based on the received energy usage information, demand response (DR) information, and profile information for saving energy to perform energy saving control in each household, and for controlling energy used by common equipment provided in the residential complex.

The home server includes an energy and environment information collecting module for collecting the energy usage information and environment sensor information from the plurality of home devices and a plurality of environment sensors provided in the household, an inquiry, statistics, and report module for providing information about energy usage status in the household in a form of graphical user interface (GUI) based on the collected energy usage information and environment sensor information, a user schedule profiler module for receiving an energy control mode based on information about schedules of members from a home user and for generating energy control mode profile information based on the received energy control mode to manage the generated energy control mode profile information, a DR profiler module for receiving a home device control mode based on the DR information from the home user and for generating home device control mode profile information based on the received home device control mode to manage the generated home device control mode profile information, a device controlling module for controlling a corresponding home device based on the energy control mode profile information, the home device control mode profile information, and a home device control command of the complex server, and a complex server interlocking module for transmitting the energy usage information to the complex server and for receiving the home device control command from the complex server.

The complex server includes an equipment status information collecting module for collecting status information from the common equipment, an equipment controlling module for generating an equipment control command on the common equipment based on the collected status information and weather information to control the common equipment, a home server interlocking module for receiving the energy usage information from the home servers and for transmitting the home device control command and an analysis report on energy usage status of the plurality of home devices to a corresponding home server, an energy analyzing and reporting module for analyzing the received status information and energy usage information to generate the analysis report, an energy price analyzing module for receiving energy price information from at least one of an energy market and an energy provider to analyze the received energy price information, and a home device controlling module for generating a control command on the plurality of home devices based on the analyzed energy usage information and energy price information to control the plurality of home devices.

The complex server controls the plurality of home servers and the common equipment in each building of the residential complex.

The common equipment is at least one of photovoltaic equipment for supplying new generation energy to the residential complex and electric blinds provided in the residential complex.

According to another aspect of the present invention, there is provided a home server provided in each household of a residential complex for collecting energy usage information from a plurality of home devices provided in the household to manage the collected energy usage information, for transmitting the collected energy usage information to a complex server provided in the residential complex, and for receiving a home device control command based on the energy usage information, DR information, and energy saving profile information from the complex server to control a plurality of home devices based on the received home device control command.

According to still another aspect of the present invention, there is provided a complex server for managing energy used by a residential complex provided in each household in the residential complex to collect energy usage information from a plurality of home devices provided in the household, to manage the collected energy usage information, to receive the energy usage information, DR information, and profile information for saving energy from home servers for controlling energy used by the plurality of home devices, to perform integrated management on the received information items, to control a corresponding home server based on the received energy usage information, DR information, and profile information for saving energy, to perform energy saving control in each household, and to control energy used by the common equipment based on status information collected by common equipment provided in the residential complex.

According to still another aspect of the present invention, there is provided a method of managing energy used by a residential complex, including a complex server receiving energy usage information, environment sensor information, profile information in accordance with schedules set by a user, and DR set information from home servers provided in households of the residential complex, transmitting a home device control command based on energy price information received from at least one of an energy market and an energy provider and new generation energy generation status information received from photovoltaic equipment provided in the residential complex to a corresponding home server, analyzing the received user set schedule information to transmit the home device control command to a corresponding home server based on schedules, and receiving weather information to control at least one of the photovoltaic equipment and electric blinds provided in the residential complex.

It is possible to provide various energy saving services in each application range using home servers and complex servers in a residential complex such as a condominium and an apartment in which a large number of households reside, and to improve energy efficiency through optimal control services for various household common equipment components such as new generation energy equipment and electric blinds.

Since it is possible to provide a service for minimizing energy cost while being interlocked with a smart grid, a DR to an energy provider, and a variable energy tariff system, it is possible to maximize an economical effect.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a home and complex server based energy management system according to an embodiment of the present invention;

FIG. 2 is a block diagram illustrating a detailed structure of a home server according to an embodiment of the present invention;

FIG. 3 is a block diagram illustrating a detailed structure of a complex server according to another embodiment of the present invention; and

FIG. 4 is a timing diagram illustrating an energy management method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, the embodiments of the present invention will be described in detail with reference to the accompanying drawing.

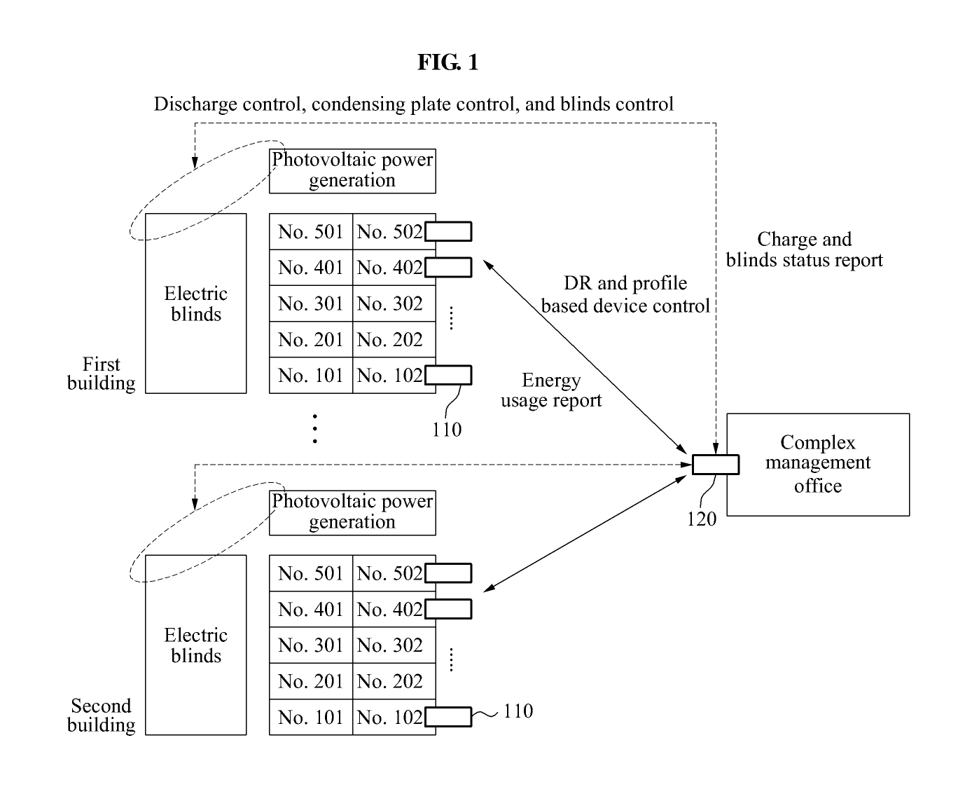

FIG. 1 is a block diagram illustrating a home and complex server based energy management system according to an embodiment of the present invention.

The energy management system according to the present invention may be realized by home servers 110 provided and managed in households in a residential complex in which a large number of households live together and an integrated management server 120 in a complex. The energy management system according to the present invention may provide various services in an environment in which common equipment is provided in each residential building to be managed and may be interlocked with a smart grid.

In detail, the energy management system according to the present invention may include the home servers 110 provided in the households of the residential complex to collect energy usage information from a plurality of home devices provided in the households, to manage the collected information, and to control energy used by the plurality of home devices and the complex server 120 for receiving the energy usage information from the home servers to perform integrated management, for controlling a corresponding home server based on the received energy usage information, demand response (DR) information, and profile information for saving energy to perform energy saving control in each household, and for controlling energy used by the common equipment provided in the residential complex.

In the drawing, messages transmitted and received among new generation energy equipment such as photovoltaic equipment and electric blinds commonly provided in each building of the residential complex, the home servers 110 provided in the households, and the complex server 120 provided in a complex management office are illustrated.

The home servers 110 provided and managed in the households may be conventional home network home servers or in-home displays (IHD). The home servers 110 collect information about a total amount of energy used by the households and an amount of energy used by the plurality of home devices and environment sensor values such as temperature, humidity, intensity of illumination, and habitation. The home servers 110 inform home users of home energy information and transmit the information about the energy used by the households, the DR information, and environment information to the complex server 120.

Similar to DR and profile based device control illustrated in FIG. 1, the home servers 110 may receive home device control messages transmitted from the complex server 120.

The home server 110 may include an energy and environment information collecting module for collecting energy usage information and environment sensor information from a plurality of home devices and a plurality of environment sensors provided in the households, an inquiry, statistics, and report module for providing information about energy usage status in the households in a form of a graphic user interface (GUI) based on the collected energy usage information and environment sensor information, a user schedule profiler module for receiving an energy control mode based on information about schedules of members from a home user and for generating energy control mode profile information based on the energy control mode to manage the generated energy control mode profile information, a DR profiler module for receiving a home device control mode based on the DR information from the home user and for generating home device control mode profile information based on the home device control mode to manage the generated home device control mode profile information, a device control module for controlling a corresponding home device based on the energy control mode profile information, the home device control mode profile information, and a home device control command of the complex server, and a complex server interlocking module for transmitting the energy usage information to the terminal server and for receiving the home device control command from the complex server.

The complex server 120 receives the energy usage information from the home servers 110 in the households to perform integrated management on the received energy usage information and controls devices in the households and energy related equipment such as photovoltaic equipment and electric blinds in accordance with energy supply information and status information.

In a manner similar to the status report on charges and blinds illustrated in FIG. 1, the complex server 120 may collect status information from equipment commonly managed in each building and may transmit discharge control, condensing plate control, and blinds control messages to equipment in each building in consideration of weather information.

The complex server 120 may include an equipment status information collecting module for collecting status information from common equipment, an equipment control module for generating an equipment control command on the common equipment based on the collected status information and weather information to control the common equipment, a home server interlocking module for receiving energy usage information from home servers and for transmitting a home device control command and an analysis report on an energy usage status of a corresponding home device to the home server, an energy information analyzing and reporting module for analyzing the received status information and energy usage information to generate the analysis report, an energy price analyzing module for receiving energy price information from at least one of an energy market and an energy provider to analyze the received energy price information, and a home device control module for generating a control command on home devices based on the analyzed energy usage information and energy price information to control the home devices.

The complex server may control the plurality of home servers 110 and the common equipment in each building of the residential complex. Here, the common equipment may be at least one of photovoltaic equipment for supplying new generation energy to the residential complex and the electric blinds provided in the residential complex.

Therefore, the energy management system according to the present invention may provide a service for saving energy in each household and a service for saving common energy in each building to provide an optimal energy management service.

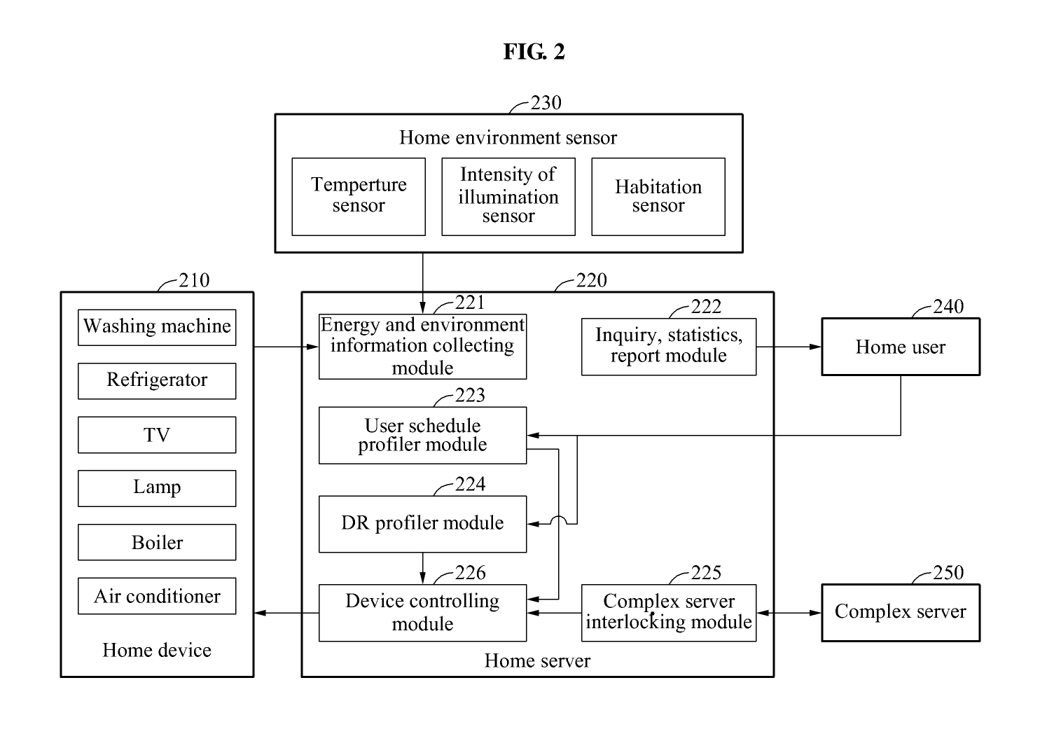

FIG. 2 is a block diagram illustrating a detailed structure of a home server according to an embodiment of the present invention.

A home server 220 according to the present invention collects energy usage information from a plurality of home devices 210 provided in a household to manage the collected energy usage information, transmits the collected energy usage information to a complex server 250 provided in a residential complex, and receives a home device control command based on energy usage information, DR information, and energy saving profile information from the complex server 250 to control the plurality of home devices 210 based on the home device control command.

FIG. 2 illustrates a detailed structure and an interface of the home server in each household described in FIG. 1 and a relationship between modules. Hereinafter, the home server 220 according to the present invention will be described in detail with reference to FIG. 2.

The plurality of home devices 210 represents representative home appliances and air conditioning and heating devices used by households such as a washing machine, a refrigerator, a television set, a lamp, a boiler, an air conditioner. The home server 220 collects information about an amount of energy used from the plurality of home devices 210 and controls the plurality of home devices 210 in accordance with schedule and DR profiles set by a user.

A home environment sensor 230 includes sensors for collecting various home environment information items such as temperature, humidity, intensity of illumination, and habitation. Information collected by the home environment sensors 230 is transmitted to the home server 220 and is used for recognizing a home status and for controlling devices and equipment linked with a peripheral environment.

A home user 240 and the complex server 250 are objects to be interfaced to which the home server 220 is externally linked. The home user 240 may be reported of an amount of energy used through the home server 220 having inquiry, statistics, and report functions in the form of GUI. In addition, the home user 240 may perform a management function of setting a user set home device control profile based on the schedules of members or a device that participates in DR.

The home server 220 mutually interfaces with the plurality of home devices 210, the home environment sensor 230, the home user 240, and the complex server 250 to perform a home energy optimal management service, transmits energy and status information of each household, and receives control information from the complex server 250.

The home server 220 may include an energy and environment information collecting module 221, an inquiry, statistics, and report module 222, a user schedule profiler module 223, a DR profiler module 224, a complex server interlocking module 225, and a device controlling module 226.

The energy and environment information collecting module 221 collects energy usage information of each device and environment sensor information such as temperature, humidity, intensity of illumination, and habitation from the plurality of environment sensors 230 provided in a household.

The inquiry, statistics, and report module 222 may provide information about energy usage status in a household to the home user 240 in the form of GUI based on the energy usage information and the environment sensor information collected by the energy and environment information collecting module 221.

The user schedule profiler module 223 receives an energy control mode based on information about the schedules of members from the home user 240 and generates energy control mode profile information based on the received energy control mode to manage the generated energy control mode profile information. Therefore, the user schedule profiler module 223 may provide a convenient device control service through various profiles such as the schedules of the members and a vacation mode, a holiday mode, a go out mode, and a sleep mode.

The DR profiler module 224 receives a home device control mode based on DR information from the home user 240 and generates home device control the mode profile information based on the received home device control mode to manage the generated home device control mode profile information. Therefore, the home user 240 may determine the presence of device control in connection with a DR service in home energy equipment such as a lamp, a water heater, and an air conditioner and home appliances such as a washing machine, a refrigerator, and a television through the DR profiler module 224.

The complex server interlocking module 225 interlocked with the complex server 250 transmits the home energy usage information collected by the home server 220 to the complex server 250 and receives a home device control command such as device control and management messages from the complex server 250 to transmit the received home device control command to the home user 240.

The device control module 226 controls a corresponding home device 210 based on the energy control mode profile information, the home device control mode profile information, and the home device control command from the complex server 250. For example, the device control module 226 may perform a device control function suitable for a situation, in consideration of a user set schedule based control profile, a DR based control profile, and the control command received from the complex server 250 in order to perform a function of controlling home equipment and home appliances.

The home server 220 is provided in each of the households that form the residential complex and is independently realized and managed or is realized and managed to be interlocked with a complex server to provide an energy saving service.

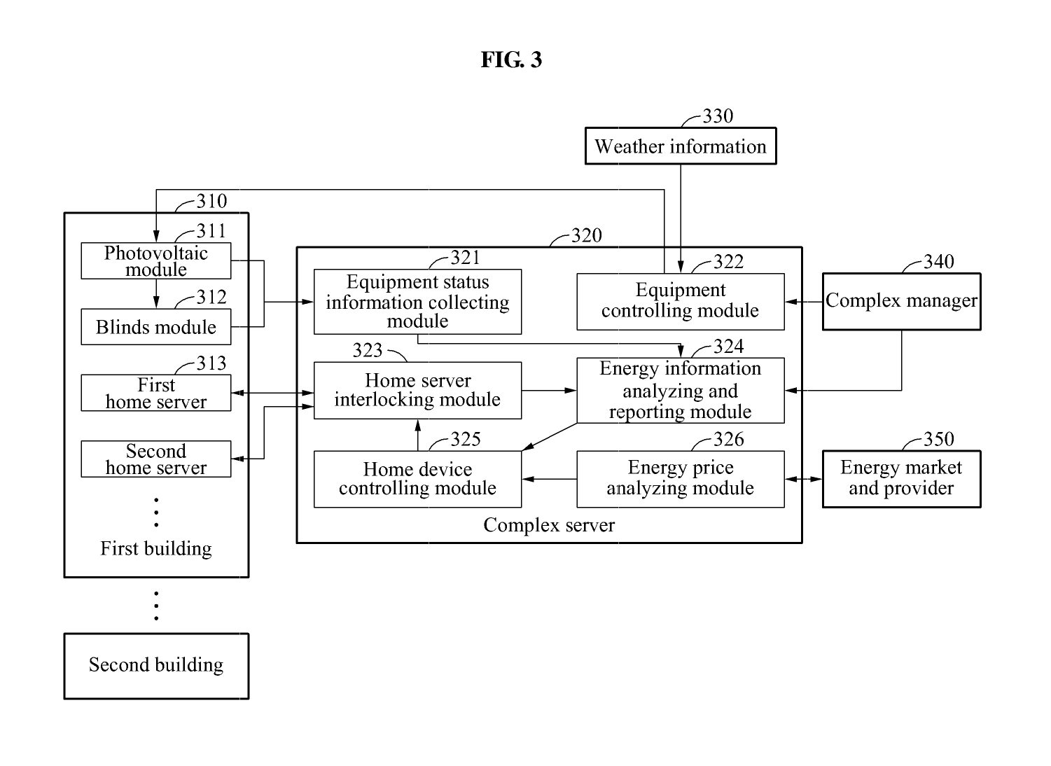

FIG. 3 is a block diagram illustrating a detailed structure of a complex server according to another embodiment of the present invention.

A complex server 320 according to the present invention is provided in each household in the residential complex, collects energy usage information from a plurality of home devices provided in the household to manage the collected energy usage information, receives energy usage information, DR information, and profile information for saving energy from home servers 313 for controlling energy used by the plurality of home devices to perform integrated management on the information items, controls a corresponding home server 313 based on the received energy usage information, DR information, and profile information for saving energy to perform energy saving control in each household, and controls energy used by common equipment components 311 and 312 based on the collected status information.

In FIG. 3, a first building 310 in the residential complex formed of a plurality of buildings may include a photovoltaic module 311 and a blinds module 312 as the common equipment components and the home servers 313 in each household.

The photovoltaic module 311 provided in each building as a power energy generating apparatus using solar light may be integrated with the rooftop of an apartment or the exterior of a building such as a veranda in each floor to be managed.

The blinds module 312 in which the angle and opening and closing of blinds may be controlled through a control message may be controlled by the complex server in accordance with weather and dimming.

Weather information 330 includes various weather information items provided from the weather center. The complex server 320 may effectively control the photovoltaic module 311 and the blinds module 312 based on the weather information.

A complex manager 340 may synthetically analyze energy usage and generation by the residential complex and may transmit a control and analysis report on devices in each household and common equipment to a corresponding household when required in consideration of energy supply cost.

The complex server 320 for providing an integrated energy management service to the residential complex analyzes energy in each household and controls common energy equipment.

The complex server 320 may include an equipment status information collecting module 321, an equipment controlling module 322, a home server interlocking module 323, an energy information analyzing and reporting module 324, a home device controlling module 325, and an energy price analyzing module 326.

The equipment status information collecting module 321 for collecting current status information from common equipment to manage the collected current status information collects information about a charge status of a photovoltaic apparatus or information about current opening and closing status and slope of electric blinds.

The equipment control module 322 generates an equipment control command on the common equipment components 311 and 312 based on the status information collected by the equipment status information collecting module 321 and the weather information 330 to control the corresponding common equipment components 311 and 312.

The home server interlocking module 323 interlocked with the home servers 313 receives energy usage information from the home servers 313 and transmits a home device control command and an analysis report on the energy usage status of home devices to a corresponding home server.

The energy information analyzing and reporting module 324 analyzes the status information and the energy usage information received by the equipment status information collecting module 321 to generate a report. For example, the information items collected by the equipment status information collecting module 321 may be synthetically managed by the energy information analyzing and reporting module 324 as well as various information items in a complex, and may be interpreted by the complex manager 340.

The home device controlling module 325 generates a control command on home devices based on the energy usage information and the energy price information that are analyzed by the energy information analyzing and reporting module 324 to control the home devices.

The energy price analyzing module 326 receives energy price information from at least one of an energy market and an energy provider to analyze the received energy price information. For example, the energy price analyzing module 326 may perform a device and equipment control function by the home device controlling module 325 based on the energy price information determined by an energy market and provider 350 when an energy cost is high or when DR is necessary.

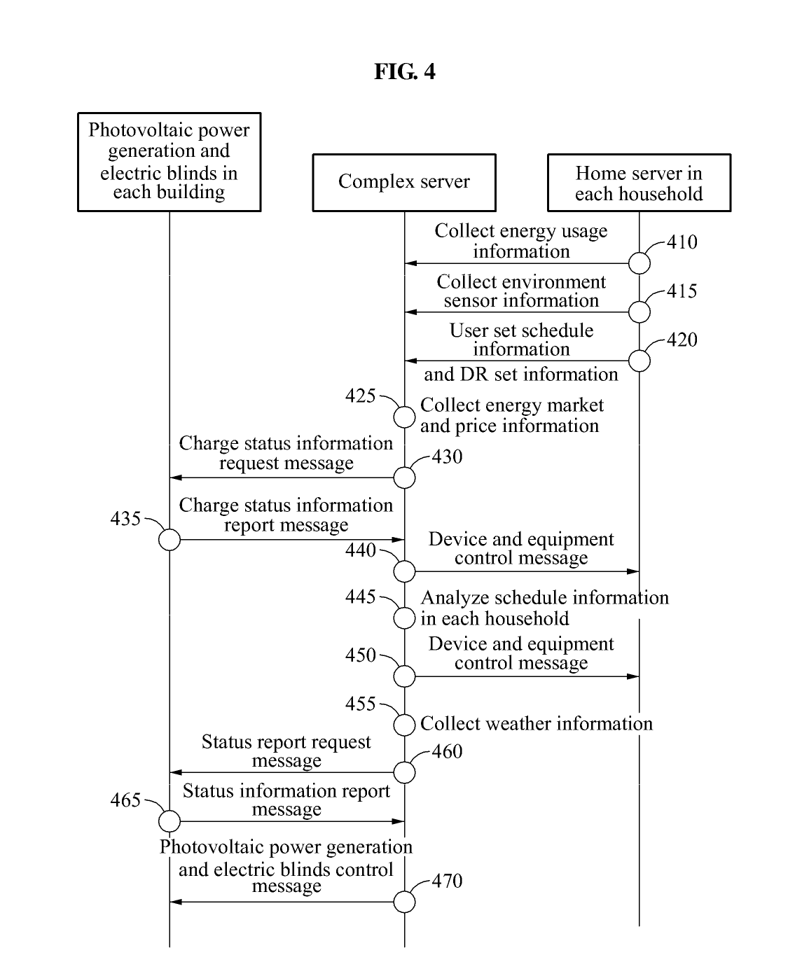

FIG. 4 is a timing diagram illustrating an energy management method according to an embodiment of the present invention. FIG. 4 illustrates processes and an order of a control function performed on each service between the home servers, the complex server, and the common equipment.

The complex server collects energy usage information from a home server in each household in operation 410, collects environment sensor information in operation 415, and receives schedule information and DR setting information that are set by a user in a form of a profile in operation 420.

When the complex server receives current energy price information from at least one of an energy market and an energy provider in operation 425 to analyze the received current energy price information, receives charge status information by photovoltaic equipment provided in a residential complex in operations 430 and 435, and transmits a home device control command based on new generation energy generation status information to a corresponding home server in operation 440 to perform optimal energy control on devices and equipment in each household.

In addition, the complex server analyzes the received user set schedule information in operation 445 and transmits a control command suitable for a corresponding schedule to a corresponding home server based on the schedule information in operation 450 to effectively control energy usage although members do not control the energy usage directly.

In addition, the complex server collects weather information in operation 455 and requests status information to a photovoltaic apparatus or electric blinds in operations 460 and 465 to control a photovoltaic condensing plate and the slope and opening and closing of blinds in accordance with current weather in operation 370 so that the common equipment may have optimal effect.

Therefore, according to the present invention, it is possible to provide various services for saving energy to a residential complex such as a condominium and an apartment in which a plurality of households reside and to improve energy efficiency through an optimal control service for various household common equipment components such as new generation energy equipment and electric blinds. Since it is possible to provide a service interlocked with a smart grid, DR to an energy provider, and a variable energy tariff to minimize energy cost, it is possible to maximize economical effect.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An energy management system for managing energy used by a residential complex, the energy management system comprising:
home servers provided in households in the residential complex to collect energy usage information from a plurality of home devices provided in each of the households, to manage the collected energy usage information, and to control energy used by the plurality of home devices; and
a complex server for receiving the energy usage information from the home servers to perform integrated management on the received energy usage information, for controlling a corresponding home server based on the received energy usage information, demand response (DR) information, and profile information for saving energy to perform energy saving control in each household, and for controlling energy used by common equipment provided in the residential complex.

2. The energy management system of claim 1, wherein the home server comprises:
an energy and environment information collecting module for collecting the energy usage information and environment sensor information from the plurality of home devices and a plurality of environment sensors provided in the household;
an inquiry, statistics, and report module for providing information about energy usage status in the household in a form of graphical user interface (GUI) based on the collected energy usage information and environment sensor information;
a user schedule profiler module for receiving an energy control mode based on information about schedules of members of a household and for generating energy control mode profile information based on the received energy control mode to manage the generated energy control mode profile information;
a DR profiler module for receiving a home device control mode based on the DR information from the home user and for generating home device control mode profile information based on the received home device control mode to manage the generated home device control mode profile information;
a device controlling module for controlling a corresponding home device based on the energy control mode profile information, the home device control mode profile information, and a home device control command of the complex server; and
a complex server interlocking module for transmitting the energy usage information to the complex server and for receiving the home device control command from the complex server.

3. The energy management system of claim 1, wherein the complex server comprises:
an equipment status information collecting module for collecting status information from the common equipment provided in the residential complex;
an equipment controlling module for generating an equipment control command on the common equipment provided in the residential complex based on the collected status information and weather information to control the common equipment provided in the residential complex;
a home server interlocking module for receiving the energy usage information from the home servers and for transmitting the home device control command and an analysis report on energy usage status of the plurality of home devices to a corresponding home server;
an energy analyzing and reporting module for analyzing the received status information and energy usage information to generate the analysis report;
an energy price analyzing module for receiving energy price information from at least one of an energy market and an energy provider to analyze the received energy price information; and
a home device controlling module for generating a control command on the plurality of home devices based on the analyzed energy usage information and energy price information to control the plurality of home devices.

4. The energy management system of claim 1, wherein the complex server controls the plurality of home servers and the common equipment provided, in each building, in the residential complex.

5. The energy management system of claim 1, wherein the common equipment provided in the residential complex is at least one of photovoltaic equipment for supplying new generation energy to the residential complex and electric blinds provided in the residential complex.

6. A home server provided in each household of a residential complex for collecting energy usage information from a plurality of home devices provided in the household to manage the collected energy usage information, for transmitting the collected energy usage information to a complex server provided in the residential complex, and for receiving a home device control command based on the energy usage information, DR information, and energy saving profile information from the complex server to control a plurality of home devices based on the received home device control command.

7. The home server of claim 6, wherein the home server comprises:
an energy and environment information collecting module for collecting the energy usage information and environment sensor information from the plurality of home devices and a plurality of environment sensors provided in the household;
an inquiry, statistics, and report module for providing information about energy usage status in the household in a form of graphic user interface (GUI) based on the collected energy usage information and environment sensor information;
a user schedule profiler module for receiving an energy control mode based on information about schedules of members from a home user and for generating energy control mode profile information based on the received energy control mode to manage the generated energy control mode profile information;
a DR profiler module for receiving a home device control mode based on the DR information from the home user and for generating home device control mode profile information based on the received home device control mode to manage the generated home device control mode profile information;
a device controlling module for controlling a corresponding home device based on the energy control mode profile information, the home device control mode profile information, and a home device control command of the complex server; and
a complex server interlocking module for transmitting the energy usage information to the complex server and for receiving the home device control command from the complex server.

8. A complex server for managing energy used by a residential complex provided in each household in the residential complex to collect energy usage information from a plurality of home devices provided in the household, to manage the collected energy usage information, to receive the energy usage information, DR information, and profile information for saving energy from home servers for controlling energy used by the plurality of home devices, to perform integrated management on the received information items, to control a corresponding home server based on the received energy usage information, DR information, and profile information for saving energy, to perform energy saving control in each household, and to control energy used by the common equipment based on status information collected by common equipment provided in the residential complex.

9. The complex server of claim 8, wherein the complex server comprises:
an equipment status information collecting module for collecting status information from the common equipment;
an equipment controlling module for generating an equipment control command on the common equipment based on the collected status information and weather information to control the common equipment;
a home server interlocking module for receiving the energy usage information from the home servers and for transmitting the home device control command and an analysis report on energy usage status of the plurality of home devices to a corresponding home server;
an energy analyzing and reporting module for analyzing the received status information and energy usage information to generate the analysis report;
an energy price analyzing module for receiving energy price information from at least one of an energy market and an energy provider to analyze the received energy price information; and
a home device controlling module for generating a control command on the plurality of home devices based on the analyzed energy usage information and energy price information to control the plurality of home devices.

10. The complex server of claim 8, wherein the complex server controls the plurality of home servers and the common equipment in each building of the residential complex.

11. The complex server of claim 8, wherein the common equipment is at least one of photovoltaic equipment for supplying new generation energy to the residential complex and electric blinds provided in the residential complex.

12. A method of managing energy used by a residential complex, comprising:
a complex server receiving energy usage information, environment sensor information, profile information in accordance with schedules set by a user, and DR set information from home servers provided in households of the residential complex;
transmitting a home device control command based on energy price information received from at least one of an energy market and an energy provider and new generation energy generation status information received from photovoltaic equipment provided in the residential complex to a corresponding home server;
analyzing the received user set schedule information to transmit the home device control command to a corresponding home server based on schedules; and
receiving weather information to control at least one of the photovoltaic equipment and electric blinds provided in the residential complex.
